(19) United States
(12) Patent Application Publication
(10) Pub. No.: US 2011/0150355 A1
(43) Pub. Date: Jun. 23, 2011

(54) METHOD AND SYSTEM FOR DYNAMIC CONTRAST PROCESSING FOR 3D VIDEO

(76) Inventors: Marcus Kellerman, San Diego, CA (US); Xuemin Chen, Rancho Sante Fe, CA (US); Samir Hulyalkar, Newtown, PA (US); Ilya Klebanov, Thornhill (CA)

(21) Appl. No.: 12/689,572

(22) Filed: Jan. 19, 2010

Related U.S. Application Data
(60) Provisional application No. 61/287,692, filed on Dec. 17, 2009.

(51) Int. Cl. H04N 5/91; H04N 13/00; G06K 9/46; G06K 9/40; G06K 9/66

(52) U.S. Cl. 382/260; 348/42; 348/E13.001; 386/E05.003; 382/190

(57) ABSTRACT

A video processing device may enhance contrast of one or more of a plurality of view sequences extracted from a three dimensional (3D) input video stream based on contrast information derived from other sequences in the plurality of view sequences. The view sequences that are subjected to contrast enhancement and/or whose contrast information may be utilized during contrast enhancement may be selected based on one or more selection criteria, which may comprise compression bitrate utilized during communication of the input video stream. The video processing device may also perform noise reduction on one or more of the plurality of extracted view sequences during contrast enhancement operations. Noise reduction may be performed using digital noise reduction (DNR). The nose reduction may be performed separately and/or independently on each view sequence in the plurality of extracted view sequences.

### CROSS-REFERENCE TO RELATED APPLICATIONS/INCORPORATION BY REFERENCE

This patent application makes reference to, claims priority to and claims benefit from U.S. Provisional Application Ser. No. 61/287,692 (Attorney Docket Number 20698US01) which was filed on Dec. 17, 2009. This application makes reference to:

U.S. Provisional Application Ser. No. 61/287,624 (Attorney Docket Number 20677US01) which was filed on Dec. 17, 2009;

U.S. Provisional Application Ser. No. 61/287,634 (Attorney Docket Number 20678US01) which was filed on Dec. 17, 2009;

U.S. application Ser. No. 12/554,416 (Attorney Docket Number 20679US01) which was filed on Sep. 4, 2009;

U.S. application Ser. No. 12/546,644 (Attorney Docket Number 20680U501) which was filed on Aug. 24, 2009;

U.S. application Ser. No. 12/619,461 (Attorney Docket Number 20681US01) which was filed on Nov. 6, 2009;

U.S. application Ser. No. 12/578,048 (Attorney Docket Number 20682US01) which was filed on Oct. 13, 2009;

U.S. Provisional Application Ser. No. 61/287,653 (Attorney Docket Number 20683US01) which was filed on Dec. 17, 2009;

U.S. application Ser. No. 12/604,980 (Attorney Docket Number 20684US02) which was filed on Oct. 23, 2009;

U.S. application Ser. No. 12/545,679 (Attorney Docket Number 20686US01) which was filed on Aug. 21, 2009;

U.S. application Ser. No. 12/560,554 (Attorney Docket Number 20687US01) which was filed on Sep. 16, 2009;

U.S. application Ser. No. 12/560,578 (Attorney Docket Number 20688US01) which was filed on Sep. 16, 2009;

U.S. application Ser. No. 12/560,592 (Attorney Docket Number 20689US01) which was filed on Sep. 16, 2009;

U.S. application Ser. No. 12/604,936 (Attorney Docket Number 20690US01) which was filed on Oct. 23, 2009;

U.S. Provisional Application Ser. No. 61/287,668 (Attorney Docket Number 20691 US01) which was filed on Dec. 17, 2009;

U.S. application Ser. No. 12/573,746 (Attorney Docket Number 20692US01) which was filed on Oct. 5, 2009;

U.S. application Ser. No. 12/573,771 (Attorney Docket Number 20693US01) which was filed on Oct. 5, 2009;

U.S. Provisional Application Ser. No. 61/287,673 (Attorney Docket Number 20694US01) which was filed on Dec. 17, 2009;

U.S. Provisional Application Ser. No. 61/287,682 (Attorney Docket Number 20695US01) which was filed on Dec. 17, 2009;

U.S. application Ser. No. 12/605,039 (Attorney Docket Number 20696US01) which was filed on Oct. 23, 2009; and

U.S. Provisional Application Ser. No. 61/287,689 (Attorney Docket Number 20697US01) which was filed on Dec. 17, 2009.

Each of the above stated applications is hereby incorporated herein by reference in its entirety

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to video processing. More specifically, certain embodiments of the invention relate to a method and system for dynamic contrast processing for 3D video.

### BACKGROUND OF THE INVENTION

Display devices, such as television sets (TVs), may be utilized to output or playback audiovisual or multimedia streams, which may comprise TV broadcasts, telecasts and/or localized Audio/Video (A/V) feeds from one or more available consumer devices, such as videocassette recorders (VCRs) and/or Digital Video Disc (DVD) players. TV broadcasts and/or audiovisual or multimedia feeds may be inputted directly into the TVs, or it may be passed intermediately via one or more specialized set-top boxes that may enable providing any necessary processing operations. Exemplary types of connectors that may be used to input data into TVs include, but not limited to, F-connectors, S-video, composite and/or video component connectors, and/or, more recently, High-Definition Multimedia Interface (HDMI) connectors.

Television broadcasts are generally transmitted by television head-ends over broadcast channels, via RF carriers or wired connections. TV head-ends may comprise terrestrial TV head-ends, Cable-Television (CAN), satellite TV head-ends and/or broadband television head-ends. Terrestrial TV head-ends may utilize, for example, a set of terrestrial broadcast channels, which in the U.S. may comprise, for example, channels 2 through 69. Cable-Television (CATV) broadcasts may utilize even greater number of broadcast channels. TV broadcasts comprise transmission of video and/or audio information, wherein the video and/or audio information may be encoded into the broadcast channels via one of plurality of available modulation schemes. TV Broadcasts may utilize analog and/or digital modulation format. In analog television systems, picture and sound information are encoded into, and transmitted via analog signals, wherein the video/audio information may be conveyed via broadcast signals, via amplitude and/or frequency modulation on the television signal, based on analog television encoding standard. Analog television broadcasters may, for example, encode their signals using NTSC, PAL and/or SECAM analog encoding and then modulate these signals onto a VHF or UHF RF carriers, for example.

In digital television (DTV) systems, television broadcasts may be communicated by terrestrial, cable and/or satellite head-ends via discrete (digital) signals, utilizing one of available digital modulation schemes, which may comprise, for example, QAM, VSB, QPSK and/or OFDM. Because the use of digital signals generally requires less bandwidth than analog signals to convey the same information, DTV systems may enable broadcasters to provide more digital channels within the same space otherwise available to analog television systems. In addition, use of digital television signals may enable broadcasters to provide high-definition television (HDTV) broadcasting and/or to provide other non-television related service via the digital system. Available digital television systems comprise, for example, ATSC, DVB, DMB-T/H and/or ISDN based systems. Video and/or audio information may be encoded into digital television signals utilizing various video and/or audio encoding and/or compression algorithms, which may comprise, for example, MPEG-1/2, MPEG-4 AVC, MP3, AC-3, AAC and/or HE-AAC.

Most TV broadcasts (and similar video feeds), nowadays, utilize video processing applications that enable broadcasting video images in the form of bit streams that comprise information regarding characteristics of the image to be displayed. These video applications may utilize various interpolation and/or rate conversion functions to present content comprising still and/or moving images on display devices. For example, de-interlacing functions may be utilized to convert moving and/or still images to a format that is suitable for certain types of display devices that are unable to handle interlaced content. TV broadcasts, and similar video feeds, may be interlaced or progressive. Interlaced video comprises fields, each of which may be captured at a distinct time interval. A frame may comprise a pair of fields, for example, a top field and a bottom field. The pictures forming the video may comprise a plurality of ordered lines. During one of the time intervals, video content for the even-numbered lines may be captured. During a subsequent time interval, video content for the odd-numbered lines may be captured. The even-numbered lines may be collectively referred to as the top field, while the odd-numbered lines may be collectively referred to as the bottom field. Alternatively, the odd-numbered lines may be collectively referred to as the top field, while the even-numbered lines may be collectively referred to as the bottom field. In the case of progressive video frames, all the lines of the frame may be captured or played in sequence during one time interval. Interlaced video may comprise fields that were converted from progressive frames. For example, a progressive frame may be converted into two interlaced fields by organizing the even numbered lines into one field and the odd numbered lines into another field.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for dynamic contrast processing for 3D video, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary video system that may be operable to playback various TV broadcasts and/or media feeds received from local devices, in accordance with an embodiment of the invention.

FIG. 2A is a block diagram illustrating an exemplary video system that is operable to provide communication of 3D video, which may enable dynamic contrast processing for 3D video, in accordance with an embodiment of the invention.

FIG. 2B is a block diagram illustrating an exemplary video processing system that is operable to generate transport streams comprising 3D encoded video, in accordance with an embodiment of the invention.

FIG. 2C is a block diagram illustrating an exemplary video processing system that enables dynamic contrast processing for 3D video, in accordance with an embodiment of the invention.

FIG. 3 is a flow chart that illustrates exemplary steps for dynamic contrast processing for 3D video, in accordance with an embodiment of the invention.

### DETAILED DESCRIPTION OF THE INVENTION

Certain embodiments of the invention may be found in a method and system for dynamic contrast processing for 3D video. In various embodiments of the invention, a video processing device may be utilized to extract a plurality of view sequences from a compressed three-dimension (3D) input video stream, and may enhance contrast of one or more of the plurality of extracted view sequences based on contrast information derived from other sequences in the plurality of view sequences. The plurality of extracted view sequences may comprise stereoscopic left view and right view sequences of reference fields or frames. The view sequences subjected to contrast enhancement and/or the view sequences whose contrast information may be utilized during contrast enhancement operations may be selected based on one or more selection criteria, which may comprise, for example, compression bitrate utilized during communication of the input video stream. The video processing device may also perform noise reduction on one or more view sequences of the plurality of extracted view sequences during contrast enhancement operations. Noise reduction may be performed using digital noise reduction (DNR). The noise reduction may be performed separately and/or independently on each view sequence in the plurality of extracted view sequences. The video processing device may generate a 3D output video stream for playback via a 3D display device based on the plurality of extracted view sequences with enhanced contrast. The brightness and/or contrast of the generated 3D output video stream may be enhanced and/or balanced based on the contrast enhancement performed on the plurality of extracted view sequences. In instances where the display frame rate of the display device may be higher than the frame rate of the received 3D input video stream, the video processing device may perform frame upconversion operations on the 3D output video stream, using frame or field interpolation for example. The video processing device may also be utilized to locally perform graphics processing corresponding to the generated 3D output video stream. The local graphics processing may be performed based on, for example, one or more points of focus within each image in the 3D output video stream.

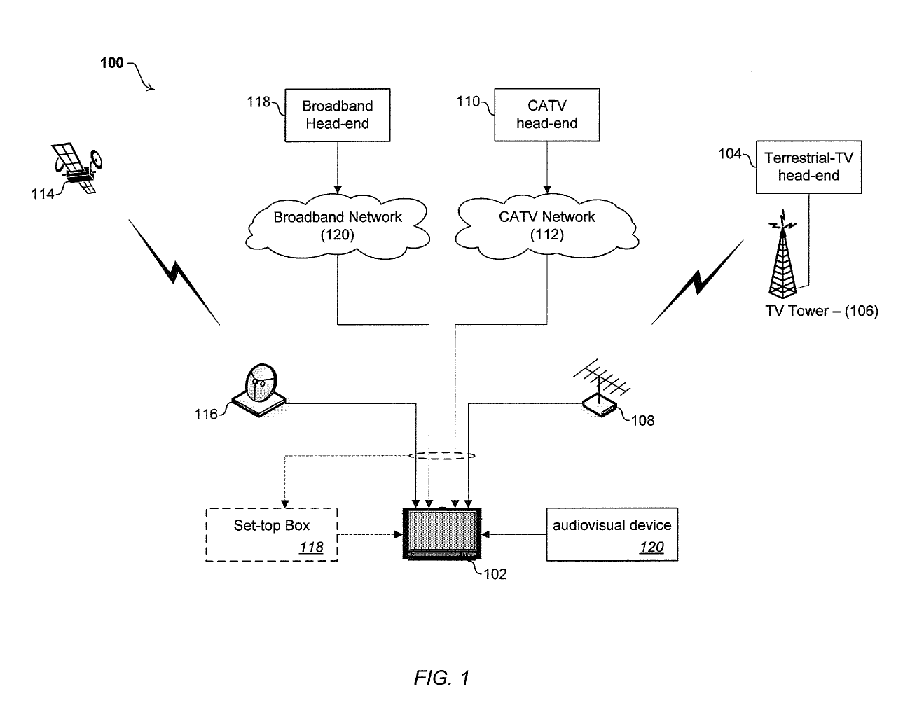

FIG. 1 is a block diagram illustrating a video system that may be operable to playback various TV broadcasts and/or media feeds received from local devices, in accordance with an embodiment of the invention. Referring to FIG. 1, there is shown a media system 100 which may comprise a display device 102, a terrestrial-TV head-end 104, a TV tower 106, a TV antenna 108, a cable-TV (CATV) head-end 110, a cable-TV (CATV) distribution network 112, a satellite-TV head-end 114, a satellite-TV receiver 116, a broadband TV head-end 118, a broadband network 120, a set-top box 122, and an audio-visual (AV) player device 124.

The display device 102 may comprise suitable logic, circuitry, interfaces and/or code that enable playing of media streams, which may comprise audiovisual data. The display device 102 may comprise, for example, a television, a monitor, and/or other display and/or audio playback devices, and/or components that may be operable to playback video streams and/or accompanying audio data, which may be received, directly by the display device 102, via intermediate devices, for example the set-top box 122, and/or from local media recording/playback devices and/or storage resources, such as the AV player device 124.

The terrestrial-TV head-end 104 may comprise suitable logic, circuitry, interfaces and/or code that may enable over-the-air broadcast of TV signals, via one or more of the TV tower 106. The terrestrial-TV head-end 104 may be enabled to broadcast analog and/or digital encoded terrestrial TV signals. The TV antenna 108 may comprise suitable logic, circuitry, interfaces and/or code that may enable reception of TV signals transmitted by the terrestrial-TV head-end 104, via the TV tower 106. The CAN head-end 110 may comprise suitable logic, circuitry, interfaces and/or code that may enable communication of cable-TV signals. The CATV head-end 110 may be enabled to broadcast analog and/or digital formatted cable-TV signals. The CATV distribution network 112 may comprise suitable distribution systems that may enable forwarding of communication from the CATV head-end 110 to a plurality of cable-TV recipients, comprising, for example, the display device 102. For example, the CAN distribution network 112 may comprise a network of fiber optics and/or coaxial cables that enable connectivity between one or more instances of the CAN head-end 110 and the display device 102.

The satellite-TV head-end 114 may comprise suitable logic, circuitry, interfaces and/or code that may enable down link communication of satellite-TV signals to terrestrial recipients, such as the display device 102. The satellite-TV head-end 114 may comprise, for example, one of a plurality of orbiting satellite nodes in a satellite-TV system. The satellite-TV receiver 116 may comprise suitable logic, circuitry, interfaces and/or code that may enable reception of downlink satellite-TV signals transmitted by the satellite-TV head-end 114. For example, the satellite receiver 116 may comprise a dedicated parabolic antenna operable to receive satellite television signals communicated from satellite television head-ends, and to reflect and/or concentrate the received satellite signal into focal point wherein one or more low-noise-amplifiers (LNAs) may be utilized to down-convert the received signals to corresponding intermediate frequencies that may be further processed to enable extraction of audio/video data, via the set-top box 122 for example. Additionally, because most satellite-TV downlink feeds may be securely encoded and/or scrambled, the satellite-TV receiver 116 may also comprise suitable logic, circuitry, interfaces and/or code that may enable decoding, descrambling, and/or deciphering of received satellite-TV feeds.

The broadband N head-end 118 may comprise suitable logic, circuitry, interfaces and/or code that may enable multimedia/TV broadcasts via the broadband network 120. The broadband network 120 may comprise a system of interconnected networks, which enables exchange of information and/or data among a plurality of nodes, based on one or more networking standards, including, for example, TCP/IP. The broadband network 120 may comprise a plurality of broadband capable sub-networks, which may include, for example, satellite networks, cable networks, DVB networks, the Internet, and/or similar local or wide area networks, that collectively enable conveying data that may comprise multimedia content to plurality of end users. Connectivity may be provided via the broadband network 120 based on copper-based and/or fiber-optic wired connection, wireless interfaces, and/or other standards-based interfaces. The broadband TV head-end 118 and the broadband network 120 may correspond to, for example, an Internet Protocol Television (IPTV) system.

The set-top box 122 may comprise suitable logic, circuitry, interfaces and/or code that may enable processing of TV and/or multimedia streams/signals transmitted by one or more TV head-ends external to the display device 102. The AV player device 124 may comprise suitable logic, circuitry, interfaces and/or code that enable providing video/audio feeds to the display device 102. For example, the AV player device 124 may comprise a digital video disc (DVD) player, a BluRay player, a digital video recorder (DVR), a video game console, a surveillance system, a personal computer (PC) capture/playback card and/or a stand-alone CH3/4 modulator box. While the set-top box 122 and the AV player device 124 are shown are separate entities, at least some of the functions performed via the top box 122 and/or the AV player device 124 may be integrated directly into the display device 102.

In operation, the display device 102 may be utilized to playback media streams received from one of available broadcast head-ends, and/or from one or more local sources. The display device 102 may receive, for example, via the TV antenna 108, over-the-air TV broadcasts from the terrestrial-TV head end 104 transmitted via the TV tower 106. The display device 102 may also receive cable-TV broadcasts, which may be communicated by the CATV head-end 110 via the CATV distribution network 112; satellite TV broadcasts, which may be communicated by the satellite head-end 114 and received via the satellite receiver 116; and/or Internet media broadcasts, which may be communicated by the broadband TV head-end 118 via the broadband network 120.

TV head-ends may utilize various formatting schemes in TV broadcasts. Historically, TV broadcasts have utilized analog modulation format schemes, comprising, for example, NTSC, PAL, and/or SECAM. Audio encoding may comprise utilization of separate modulation scheme, comprising, for example, BTSC, NICAM, mono FM, and/or AM. More recently, however, there has been a steady move towards Digital TV (DTV) based broadcasting. For example, the terrestrial-TV head-end 104 may be enabled to utilize ATSC and/or DVB based standards to facilitate DTV terrestrial broadcasts. Similarly, the CATV head-end 110 and/or the satellite head-end 114 may also be enabled to utilize appropriate encoding standards to facilitate cable and/or satellite based broadcasts.

The display device 102 may be operable to directly process multimedia/TV broadcasts to enable playing of corresponding video and/or audio data. Alternatively, an external device, for example the set-top box 122, may be utilized to perform processing operations and/or functions, which may be operable to extract video and/or audio data from received media streams, and the extracted audio/video data may then be played back via the display device 102.

In exemplary aspect of the invention, the media system 100 may be operable to support three-dimension (3D) video. Most video content is currently generated and played back, in two-dimensional (2D) format. There has been a recent push, however, towards the development and/or use of three-dimensional (3D) video. In various video related applications such as, for example, the DVD/BluRay movies and/or the digital TV, 3D video may be more desirable because it is generally more realistic to humans to perceive 3D rather than 2D images. Various methods may be utilized to capture, generate (at capture or playtime), or render 3D video. 3D video may be generated utilizing stereoscopic 3D imaging/video. In stereoscopic video, 3D video impression is generated by rendering multiple views, for example a left view and a right view, which corresponds to the viewer's left eye and right eye. Accordingly, left view and right view video sequences may be captured and/or processed to enable creating 3D impressions. Information for left view and the right view may be communicated as separate streams, or may combined into a single transport stream and separated into different view sequences by the receiving/display end device.

Various compression and/or encoding standards may be utilized to enable compressing and/or encoding of the view sequences into transport streams. For example, the separate left and right view video sequences may be compressed based on MPEG-2 MVP, H.264 and/or MPEG-4 advanced video coding (AVC) or MPEG-4 multi-view video coding (MVC). In this regard, one or more of the head-ends, for example cable or satellite, may be operable to communicate 3D video content to the display device 102. The AV player device 124 may also be operable to play previously recorded and/or generated 3D video content, from media storage element that may be read via the AV player device 124 for example.

Once received, the transport streams may be processed to extract the left view and right view video sequences, and 3D video frames may then be produced by combining, for example, data from the left view and right view video sequences, respectively. Perceiving the 3D images may necessitate use of specialized stereoscopic glasses. Alternatively, glasses-free 3D displays may be developed and/or utilized to enable providing 3D viewing experience, the so called auto-stereoscopic 3D video, without the need to use specialized viewing glasses, based on, for example, such techniques as lenticular screens. For example, the display device 102 may be operable to generate 3D video by processing and/or combining, for example, left view and right view video sequences, respectively, and the utilized the generated 3D video to provide 3D viewing experience with or without specialized 3D glasses.

During such stereoscopic 3D video operations, the view sequences may be generated and/or processed differently such that one view sequence may comprise more information than the other. For example, in instances where the stereoscopic 3D video comprises left and right view sequences, the left view may be utilized as the primary or base video source whereas the right view may be utilized as an enhancement video source. In this regard, the enhancement video source may be utilized to enable generating the 3D impression by providing, for example, data that enable creating depth perception. Consequently, the right and left view sequences may be compressed and/or encoded differently, which may result in the left and right view sequences being allocated different bitrates during video communication. For example, the left view sequence may be compressed such that the resultant data stream is communicated at 5 Mbps whereas the resultant output data stream from compressing the right view sequence may be communicated at 3 Mbps. Accordingly, the different compression/encoding of the views, as reflected in the different transmission bitrates, may result in different video related information that may be determined from processing the view sequences separately. For example, the communicated right and left view sequences may comprise different contrast and/or brightness information. In this regard, the left view, which is communicated using the higher bitrate for example, may comprise better contrast information yielding, for example, smoother images. Furthermore, because the view sequences are transmitted at different bitrates, different noise may be introduced to each view sequence during the communication.

In various embodiments of the invention, the view sequences may be processed separately such that the view sequences with more video information, e.g. comprising higher contrast and/or brightness data, may be utilized to dynamically enhance the contrast and/or brightness of images corresponding to view sequences with lower contrast data. The view sequences with more video information may also be utilized to enable equalizing contrast and/or balancing brightness of the resultant 3D video stream generated during display operation. In addition, and since the noise introduced to each of the view sequences may vary due to the different compression utilized with the different view sequences, noise reduction operations may be performed separately and/or independently on the view sequences. During such operations, the view sequences may be categorized and/or processed based on, for example, transmission bitrates.

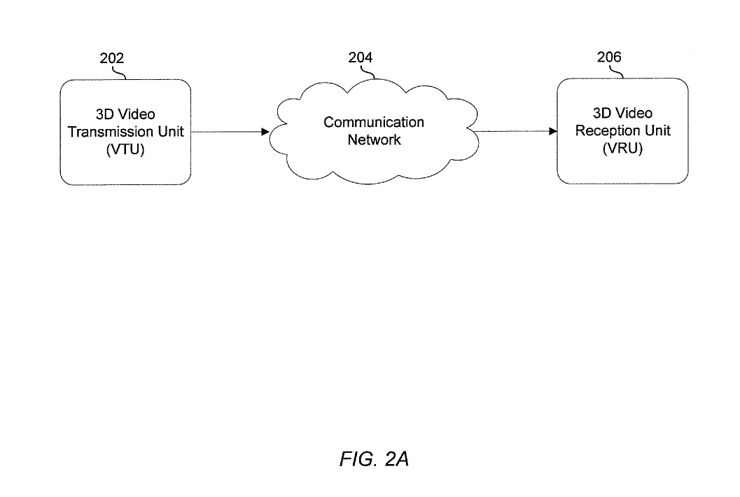

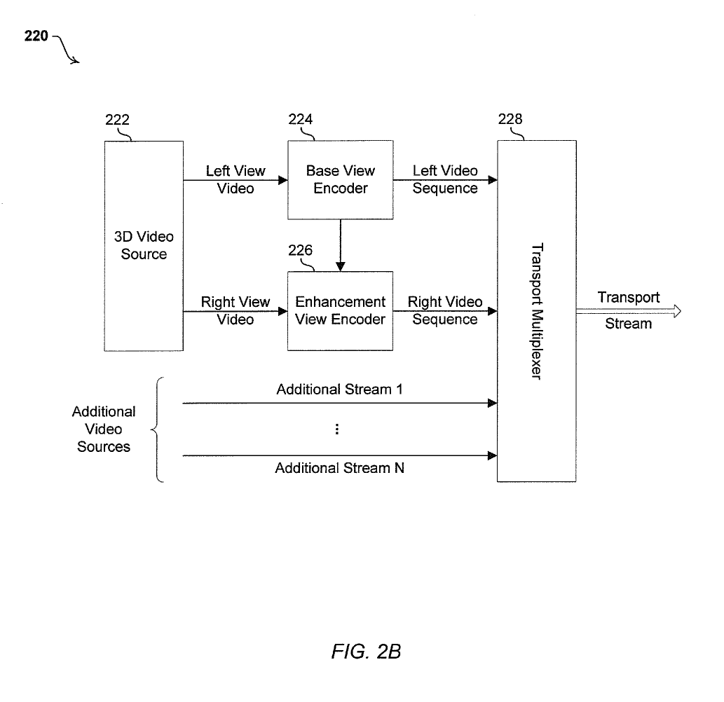

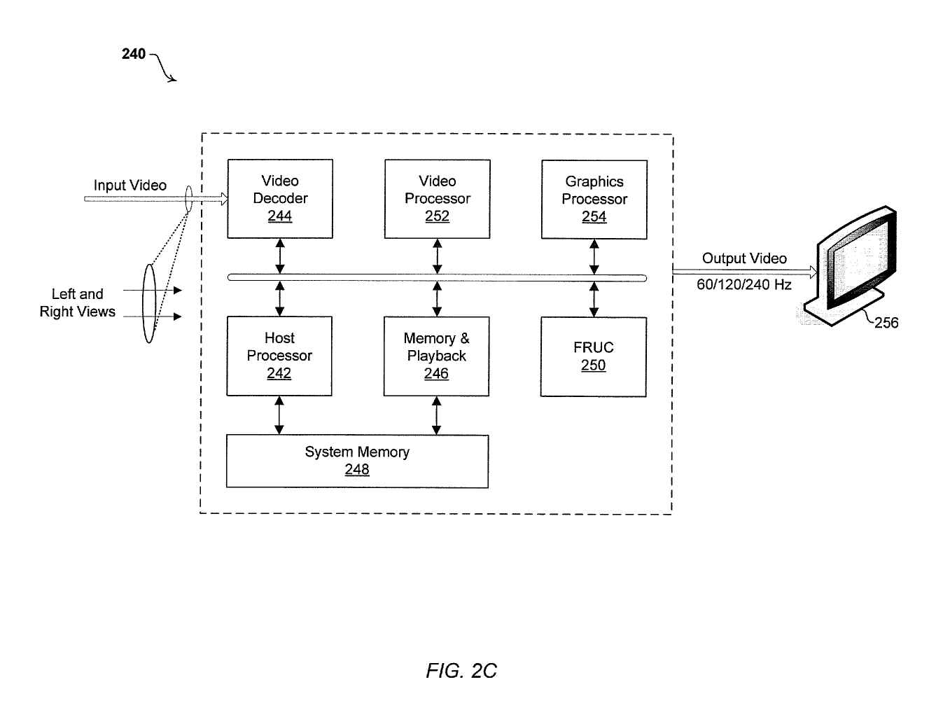

FIG. 2A is a block diagram illustrating an exemplary video system that is operable to provide communication of 3D video, which may enable dynamic contrast processing for 3D video, in accordance with an embodiment of the invention. Referring to FIG. 2A, there is shown a 3D video transmission unit (3D-VTU) 202, a communication network 204, and a video reception unit (3D-VRU) 206.

The 3D-VTU 202 may comprise suitable logic, circuitry, interfaces and/or code that may be operable to generate transport streams comprising encoded video content, which may be communicated via the communication network 204, for example, to the 3D-VRU 206. The 3D-VTU 202 may be operable to encode 3D video contents corresponding, for example, to TV broadcasts. In this regard, the 3D-VTU 202 may correspond to, for example, the terrestrial head-end 104, the CAN head-end 110, the satellite head-end 114, and/or the broadband head-end 118 of FIG. 1. In instances where a 3D video may be encoded, the 3D-VTU 202 may be operable to encode, for example, the 3D video as a left view video stream and a right view video stream, of which each may be transmitted in a different channel to the 3D-VRU 206. Transport streams communicated via the 3D-VTU 202 may comprise additional video content, in addition to the primary video content. Exemplary additional video content may comprise advertisement information. In this regard, the 3D-VTU 202 may be operable to insert, via splicing for example, advertisement information into the transport streams comprising encoded 3D video streams. The advertising information may be inserted as 3D or 2D video streams.

The communication network 204 may comprise suitable logic, circuitry, interfaces and/or code that may be operable to provide platforms for communication between the 3D-VTU 202 and the 3D-VRU 206, to facilitate communication of transport streams comprising 3D video content. The communication network 204 may be implemented as a wired or wireless communication network. The communication network 204 may correspond to, for example, the CATV distribution network 112 and/or the broadband network 122 of FIG. 1.

The 3D-VRU 206 may comprise suitable logic, circuitry, interfaces and/or code that may be operable to receive and process transport streams comprising video content, communicated, for example, by the 3D-VTU 202 via the communication network 204. In this regard, the operations of the 3D-VRU 206 may be performed, for example, via the display device 102 and/or the set-top box 122 of FIG. 1. The received transport stream may comprise encoded 3D video content corresponding to, for example, entertainment programs in 3D TV broadcasts. The received transport stream may also comprise additional video content, such as, for example, advertising streams. The 3D-VRU 206 may be operable to process the received transport stream to separate and/or extract various video contents in the transport stream, and may be operable to decode and/or process the extracted video streams and/or contents to facilitate display operations.

In operation, the 3D-VTU 202 may be operable to generate transport streams comprising 3D video contents corresponding to, for example, entertainment programs included in 3D TV programs. The 3D-VTU 202 may encode, for example, the 3D video content as stereoscopic video comprising left view and right view sequences. Additional video content, which may comprise, for example, advertisement information, may be inserted into the transport stream along with the encoded 3D video view streams. The transport stream may be communicated with the 3D-VRU 206 over the communication network 204. The 3D-VRU 206 may be operable to receive and process the transport stream to facilitate playback of video content included in the transport stream via display devices. In this regard, the 3D-VRU 206 may be operable to, for example, demultiplex the received transport stream into encoded 3D video streams of the 3D TV program and additional video streams.

The 3D-VRU 206 may be operable to decode the encoded 3D video streams of the 3D TV program for display. Advertising streams may be extracted based on, for example, user profile and/or device configuration, from the encoded 3D video streams. Depending on device configuration and/or user preferences, the extracted advertising streams may be presented within the 3D TV program or removed for display separately. The 3D-VRU 206 may also be operable to locally process graphics corresponding to the displayed video content, to produce corresponding targeted graphic objects. The targeted graphic objects may be located, for example, according to timing information indicated in associated 3D scene graphics. The 3D-VRU 206 may be operable to splice the targeted graphic objects into the decoded 3D video based on the focal point of view. Where a 3D capable display device is utilized, the resulting compound 3D video may played as 3D video via the display devices. In some instances, however, where only 2D capable display devices are utilized, the resulting compound 3D video may be converted, via the 3D-VRU 206 into a 2D video for display.

In an exemplary aspect of the invention, the 3D-VRU 206 may be operable to perform dynamic contrast processing on received transport streams. In this regard, in instances where the received 3D video streams may comprise a plurality of view sequences that are utilized in generating 3D video display experience, the 3D-VRU 206 may be operable to utilize contrast information from one or more view sequences that may be deemed to contain high contrast information to enhance remaining view sequences. In this regard, the 3D-VRU 206 may select, for example, view sequences with higher compression bitrates to enhance view sequences with lower compression bitrates, substantially as described with regard to FIG. 1. Furthermore, since the bitrates of the compressed view sequences within the communicated transport streams may differ, noise introduced during communication of transport streams may also differ. Therefore, the noise reduction operations performed on the view sequences extracted from the received transport streams may be performed differently and/or independently via the 3D-VRU 206.

FIG. 2B is a block diagram illustrating an exemplary video processing system that is operable to generate transport streams comprising 3D encoded video, in accordance with an embodiment of the invention. Referring to FIG. 2B, there is shown a video processing system 220, a 3D video source 222, a base view encoder 224, an enhancement view encoder 226, and a transport multiplexer 228.

The video processing system 220 may comprise suitable logic, circuitry, interfaces and/or code that may be operable to capture, generate, and/or process 3D video data, and to generate transport streams comprising the 3D video. The video processing system 220 may comprise, for example, the 3D video source 222, the base view encoder 224, the enhancement view encoder 226, and/or the transport multiplexer 228. For example, the video processing system 220 may be integrated into the 3D-VTU 202 to facilitate generation of 3D video and/or transport streams comprising 3D video.

The 3D video source 222 may comprise suitable logic, circuitry, interfaces and/or code that may be operable to capture source 3D video contents. The 3D video source 222 may be operable to generate a left view video and a right view video from the captured source 3D video contents, to facilitate 3D video display/playback. The left view video and the right view video may be communicated to the base view encoder 224 and, for example, the enhancement view encoder 226, respectively, for video compressing.

The base view encoder 224 may comprise suitable logic, circuitry, interfaces and/or code that may be operable to encode the left view video from the 3D video source 222, for example on frame by frame basis. The base view encoder 224 may be operable to utilize various video encoding and/or compression algorithms such as specified in MPEG-2, MPEG-4, AVC, VC1, VP6, and/or other video formats to form compressed and/or encoded video contents for the left view video from the 3D video source 222. In addition, the base view encoder 224 may be operable to communication information, such as the scene information from base view coding, to the enhancement view encoder 226 to be used for enhancement view coding.

The enhancement view encoder 226 may comprise suitable logic, circuitry, interfaces and/or code that may be operable to encode the right view video from the 3D video source 222, for example on frame by frame basis. The enhancement view encoder 226 may be operable to utilize various video compression algorithms such as specified in MPEG-2, MPEG-4, AVC, VC1, VP6, and/or other video formats to form compressed or coded video content for the right view video from the 3D video source 222. Although a single enhancement view encoder 226 is illustrated in FIG. 2B, the invention may not be so limited. Accordingly, any number of enhancement view video encoders may be used for processing the left view video and the right view video generated by the 3D video source 222 without departing from the spirit and scope of various embodiments of the invention.

The transport multiplexer 228 may comprise suitable logic, circuitry, interfaces and/or code that may be operable to merge a plurality of video streams into a single compound video stream, namely a transport stream (TS), for transmission. The TS may comprise the base view stream, the enhancement view stream and a plurality of addition video streams, which may comprise, for example, advertisement streams. The additional streams may be captured directly within the video processing system 220 or alternatively may be received for dedicated sources. For example, an advertisement source may provide available advertisement video contents, via a plurality of advertising streams, which may be then spliced into the transport stream (TS). In this regard, the plurality of advertising streams may be inserted into any gaps within the base video stream and/or the enhancement video stream from the base view encoder 224 and the enhancement encoder 216, respectively.

In operation, the 3D video source 222 may be operable to capture source 3D video contents to produce a left view video and a right view video for video compression. The left view video may be encoded via the base view encoder 224 producing a base view stream. The right view video may be encoded via the enhancement view encoder 226 producing an enhancement view stream. The base view encoder 224 may be operable to provide information such as the scene information to the enhancement view encoder 226 for enhancement view coding. Additionally, one or more additional video streams may be multiplexed with the base view stream and/or the enhancement view stream to form a transport stream (TS) via the transport multiplexer 228. The resulting transport stream (TS) may then be communicated, for example, to the 3D-VRU 206, substantially as described with regard to FIG. 2A.

In an exemplary aspect of the invention, the transport streams generated via the video processing system 220 may enable dynamic contrast processing. In this regard, because the left view video from the 3d video source 222 is encoded via the base view encoder 224, the resultant left view sequence may comprise more video information and/or data than the right video sequence, which is generated via the enhancement view encoder 226 based on the right view video from the 3d video source 222. Accordingly, when processing the transport stream (TS), the receiving end-devices, for example the 3D-VRU 206, may utilize the contrast information within the left view sequence in the transport stream (TS) to enhance the contrast information corresponding to the right view sequence in the transport stream (TS), substantially as described with regard to FIG. 1.

FIG. 2C is a block diagram illustrating an exemplary video processing system that enables dynamic contrast processing for 3D video, in accordance with an embodiment of the invention. Referring to FIG. 2C there is shown a video processing system 240, a host processor 242, an video decoder 244, a memory and playback module 246, a system memory 248, a frame rate up-conversion (FRUC) module 250, a video processor 252, a graphics processor 254, and a display 256.

The video processing system 240 may comprise suitable logic, circuitry, interfaces and/or code that may be operable to receive and process 3D video data in a compression format and may render reconstructed output video for display. The video processing system 240 may comprise, for example, the host processor 242, the video decoder 244, the memory and playback module 246, the system memory 248, the FRUC module 250, the video processor 252, and/or the graphics processor 254. For example, the video processing system 240 may be integrated into the 3D-VRU 206 to facilitate reception and/or processing of transport streams comprising 3D video content communicated by the 3D-VTU 202. The video processing system 240 may be operable to handle interlaced video fields and/or progressive video frames. In this regard, the video processing system 240 may be operable to decompress and/or up-convert interlaced video and/or progressive video. The video fields, for example, interlaced fields and/or progressive video frames may be referred to as fields, video fields, frames or video frames. In an exemplary aspect of the invention, the video processing system 240 may be operable to perform dynamic contrast processing of 3D input video.

The host processor 242 may comprise suitable logic, circuitry, interfaces and/or code that may be operable to process data and/or control operations of the video processing system 240. In this regard, the host processor 242 may be operable configure and/or controlling operations of various other components and/or subsystems of the video processing system 240, by providing, for example, control signals to various other components and/or subsystems of the video processing system 240. The host processor 242 may also control data transfers with the video processing system 240, during video processing operations for example. The host processor 242 may enable execution of applications, programs and/or code, which may be stored in the system memory 248, to enable, for example, performing various video processing operations such as decompression, motion compensation operations, interpolation or otherwise processing 3D video data.

The system memory 248 may comprise suitable logic, circuitry, interfaces and/or code that may operable to store information comprising parameters and/or code that may effectuate the operation of the video processing system 240. The parameters may comprise configuration data and the code may comprise operational code such as software and/or firmware, but the information need not be limited in this regard. Additionally, the system memory 248 may be operable to store 3D video data, for example, data that may comprise left and right views of stereoscopic image data.

The video decoder 244 may comprise suitable logic, circuitry, interfaces and/or code that may be operable to process encoded video data. In this regard, video decoder 244 may be operable to demultiplex and/or parse received transport streams to extract streams and/or sequences within them, to decompress video data that may be carried via the received transport streams, and/or may perform additional security operations such as digital rights management. The compressed video data in the received transport stream may comprise 3D video data corresponding to a plurality of view stereoscopic video sequences of frames or fields, such as left and review views. The received video data may be compressed and/or encoded via MPEG-2 transport stream (TS) protocol or MPEG-2 program stream (PS) container formats, for example. In various embodiments of the invention, the left view data and the right view data may be received in separate streams or separate files. In this instance, the video decoder 244 may decompress the received separate left and right view video data based on, for example, MPEG-2 MVP, H.264 and/or MPEG-4 advanced video coding (AVC) or MPEG-4 multi-view video coding (MVC). In other embodiments of the invention, the stereoscopic left and right views may be combined into a single sequence of frames. For example, side-by-side, top-bottom and/or checkerboard lattice based 3D encoders may convert frames from a 3D stream comprising left view data and right view data into a single-compressed frame and may use MPEG-2, H.264, AVC and/or other encoding techniques. In this instance, the video data may be decompressed by the video decoder 244 based on MPEG-4 AVC and/or MPEG-2 main profile (MP), for example.

The memory and playback module 246 may comprise suitable logic, circuitry interfaces and/or code that may be operable to buffer 3D video data, for example, left and/or right views, while it is being transferred from one process and/or component to another. In this regard, the memory and playback module 246 may receive data from the video decoder 244 and may transfer data to the FRUC module 250, the video processor 252, and/or the graphics processor 254. In addition, the memory and playback module 246 may buffer decompressed reference frames and/or fields, for example, during frame interpolation, by the FRUC module 250, and/or contrast enhancement processing operations. The memory and playback module 246 may exchange control signals with the host processor 242 for example and/or may write data to the system memory 248 for longer term storage.

The FRUC module 250 may comprise suitable logic, circuitry, interfaces and/or code that may be operable to receive input video frames at one rate, for example, left and right views at 24 or 48 fps, and output the frames for display operations at a higher rate, at 60, 120 and/or 240 Hz for example. In this regard, the FRUC module 250 may interpolate one or more frames that may be inserted between the received frames to increase the number of frames per second. The FRUC module 250 may be operable to perform motion estimation and/or motion compensation in order to interpolate the frames. The FRUC module 250 may be configurable to handle, for example, stereoscopic left and right views.

The video processor 252 may comprise suitable logic, circuitry, interfaces and/or code that may be operable to process the received video data to generate one or more output video streams, which may be played via the display 256. The video processor 252 may be operable, for example, to generate video frames that may provide 3D video playback via the display 256 based on a plurality of view sequences extracted from the received transport streams. In this regard, the video processor 252 may utilize the video data, such as luma and/or chroma data, in the received view sequences of frames and/or fields. In various embodiments of the invention, the video processor 252 may be operable to perform dynamic contrast and/or brightness enhancement processing of received video data, substantially as described with regard to FIG. 1. The video processor 252 may also be operable to perform noise reduction on the received video data, utilizing, for example, dynamic noise reduction (DNR) techniques, to remove and/or mitigate noise and/or artifacts introduced during processing and/or transport stream communication.

The graphics processor 254 may comprise suitable logic, circuitry, interfaces and/or code that may be operable to perform graphics processing locally within the video processing system 240 based on, for example, the focal point of view. The graphics processor 254 may be operable to generate graphic objects that may be composited into the output video stream. The graphic objects may be generated based on the focal point of view and/or the last view of a served entertainment program. Where 2D video output is generated via the video processing system 240, the generated graphic objects may comprise 2D graphic objects. The splicing of graphic objects via the graphics processor 254 may be performed after the 2D video output stream is generated, enhanced, and upconverted via the video processor 252 and/or the FRUC module 250.

The display 256 may comprise suitable logic, circuitry, interfaces and/or code that may be operable to receive reconstructed fields and/or frames of video data after processing in the FRUC module 250 and may display corresponding images. The display 256 may be a separate device, or the display 256 and the video processing system 240 may implemented as single unitary device. The display 256 may be operable to perform 2D and/or 3D video display. In this regard, a 2D display may be operable to display video that was generated and/or processed utilizing 3D techniques.

In operation, the video processing system 240 may be utilized to facilitate reception and processing of transport stream comprising video data, and to generate and process output video streams that are playable via a local display device, such as the display 256. Processing the received transport stream may comprise demultiplexing the transport stream to extract plurality of compressed video, which may correspond to, for example, view sequences and/or additional information. Demultiplexing the transport stream may be performed within the video decoder 244, or by a separate component (not shown). The video decoder 244 may be operable to receive the transport streams comprising compressed stereoscopic video data, in multi-view compression format for example, and decode and/or decompress that video data. For example, the received transport streams may comprise left and right stereoscopic views. The video decoder 244 may be operable to decompress the received stereoscopic video data and may buffer the decompressed data via the memory and playback module 246. The decompressed video data may then be processed to enable playback via the display 256. The video processor 252 may be operable to generate output video streams, which may comprise 3D and/or 2D video, based on determination of the decompressed video data. In this regard, in instances where stereoscopic 3D video is utilized, the video processor 252 may process decompressed reference frames and/or fields, corresponding to a plurality of view sequences, which may be retrieved by the memory and playback module 246, to enable generation of corresponding 3D video steam. The generated 3D output stream may then be further processed via the FRUC module 250 and/or the graphics processor 254 prior to playback via the display 256. For example, the FRUC module 250 may perform motion compensation and/or may interpolate pixel data in one or more frames between the received frames in order to enable the frame rate up-conversion. The graphics processor 254 may be utilized to provide local graphics processing, to enable splicing, for example, graphics into the generated and enhanced video output stream, and the final video output stream may then be played via the display 256.

In various embodiments of the invention, the video processor 252 may be utilized to perform dynamic contrast and/or brightness enhancement on received video data when generating corresponding output video streams. In this regard, in instances where the received video data comprises a plurality of view sequences, the view sequences may be generated and/or processed at the point of video generation and/or capture differently such that one or more view sequence may comprise more and/or better video information. For example, in instances where the received stereoscopic 3D video data comprises left and right view sequences, the left view may be utilized, for 3D video, as primary or base video and the right view may be utilized as secondary or enhancement video source. Accordingly, the left view sequence may comprise better video information than the right view sequence. In such instance, the video processor 252 may be utilized to enhance the contrast and/or brightness in the generated corresponding 3D video streams by utilizing the contrast and/or brightness data of the left view sequence to dynamically enhance the contrast and/or brightness of the right view sequence, and to equalize contrast and/or balancing brightness of the generated 3D video stream frames.

The video processor 252 may also be operable to perform noise reduction on the received video data, to remove and/or mitigate noise and/or artifacts introduced during processing and/or transport streams communication. In this regard, the video processor 252 may utilize digital noise reduction (DNR) techniques. Where the compressed video data in the received transport stream comprises a plurality of view sequences, which may be compressed and/or encoded at different bitrates, the noise and/or artifacts introduced into the transport streams may affect the various view sequences differently. Accordingly, the video processor 252 may be operable to apply noise reduction adjustments on each of the view sequences extracted via the video processing system 240 differently and independently of remaining view sequences.

In applying the contrast and/or brightness enhancement, and/or the noise reduction, to the plurality of the view sequences extracted via the video processing system 240, selection criteria may be utilized to categorize and/or select view sequences that may processed and/or utilized during processing operations. The selection criteria may comprise, for example, compression bitrate. For example, because higher compression bitrate may signify better video data, view sequences with higher bitrates, above a predetermined and/or configurable threshold for instance, may be selected and/or used to enhance contrast information of remaining view sequences with lower compression bitrate, below some predetermined and/or configurable threshold for instance. The selection criteria may also be utilized to vary the noise reduction operations performed via the video processor 252. For example, the compression bitrates may be utilized to enable the application of different levels and/or types of DNR to the left view and right view sequences.

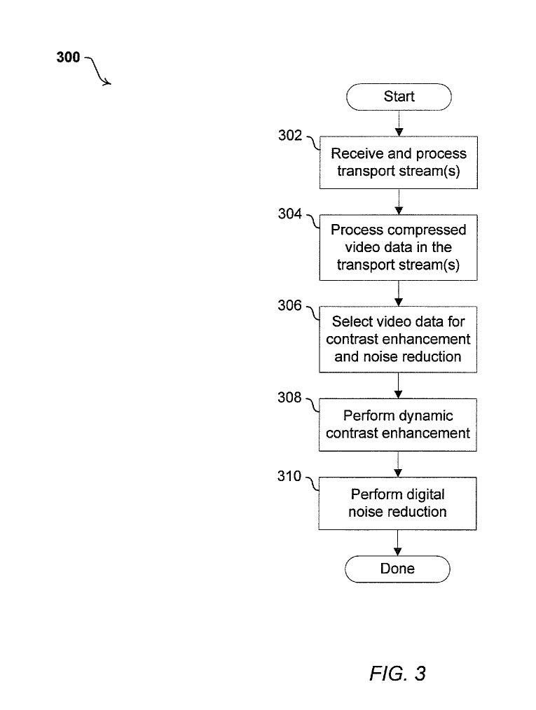

FIG. 3 is a flow chart that illustrates exemplary steps for dynamic contrast processing for 3D video, in accordance with an embodiment of the invention. Referring to FIG. 3, there is shown a flow chart 300 comprising a plurality of exemplary steps that may enable dynamic contrast processing for 3D video.

In step 302, transport streams comprising video data may be received and processed. For example, the video processing system 240 may be operable to receive and process transport streams comprising compressed video data, which may correspond to stereoscopic 3D video. In this regard, the compressed video data may correspond to a plurality of video sequences that may be utilized to generate 3D viewing experience via a suitable display device. Processing the received transport stream may comprise demultiplexing the transport stream to extract plurality of compressed video, which may correspond to, for example, view sequences and/or additional information. In step 304, the compressed video data in the received transport streams may be processed. For example, the video decoder 244 may decode the compressed video data in the received video streams to extract, for example, the corresponding left view and right view sequences.

In step 306, video data may be selected for contrast enhancement and noise reduction. For example, selection criteria may be utilized to select from among a plurality of view sequences extracted from received transport stream. In this regard, compression bitrate may be utilized, via the video processor 252 for example, to determine view sequences which may be subjected to contrast and/or brightness enhancement, and/or view sequences that may be utilized in performing any such enhancement, substantially as described with regard to, for example, FIG. 2C. In step 308, dynamic contrast and/or brightness enhancement may be performed. For example, in instances where processed received compressed data yields left view and right view sequences, and where the left view is determined to have higher compression bitrate, contrast information of the left view sequence may be utilized to enhance the contrast data for the right view sequence, and to equalize contrast and/or brightness of corresponding 3D output video stream generated via the video processor 252, for example. In step 310, noise reduction may be performed on the view sequence. Because the view sequence may be compressed and/or encoded differently, the noise reduction may be performed via the video processor 252, for example, variably based on the compression bitrate for instance. The noise reduction may be performed utilizing digital noise reduction (DNR).

Various embodiments of the invention may comprise a method and system for dynamic contrast processing for 3D video. The video processing system 240 may be utilized to extract a plurality of view sequences from a compressed three-dimension (3D) input video stream, and may enhance, via the video processor 252, contrast of one or more of the plurality of extracted view sequences based on contrast information derived from other sequences in the plurality of view sequences. The plurality of extracted view sequences may comprise stereoscopic left view and right view sequences of reference fields or frames. The view sequences subjected to contrast enhancement and/or the view sequences whose contrast information may be utilized during contrast enhancement operations may be selected, via the video processor 252, based on one or more selection criteria, which may comprise, for example, compression bitrate utilized during communication of the input video stream, via the 3D-VTU 202. The video processing system 240 may also perform, via the video processor 252, noise reduction on one or more view sequences of the plurality of extracted view sequences during contrast enhancement operations. Noise reduction may be performed using digital noise reduction (DNR). The noise reduction may be performed, via the video processor 252, separately and/or independently on each view sequence in the plurality of extracted view sequences. The video processing system 240 may generate, via the video processor 252, a 3D output video stream for playback via the display 252 based on the plurality of extracted view sequences with enhanced contrast. The brightness and/or contrast of the generated 3D output video stream may be enhanced and/or balanced, via the video processor 252 for example, based on the contrast enhancement performed on the plurality of extracted view sequences. In instances where the display frame rate of the display 256 may be higher than the frame rate of the received 3D input video stream, the video processing system 240 may perform, via the FRUC module 250, frame upconversion operations on the 3D output video stream, using frame or field interpolation for example. The video processing system 240 may also be utilized to locally perform, via the graphics processor 254, graphics processing corresponding to the generated 3D output video stream. The local graphics processing may be performed based on, for example, one or more points of focus within each image in the 3D output video stream.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for dynamic contrast processing for 3D video.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
performing by one or more processors and/or circuits in a video processing system:
extracting a plurality of view sequences from a compressed three-dimension (3D) input video stream; and
modifying contrast for one or more of said plurality of extracted view sequences based on contrast information derived from said plurality of extracted view sequences, wherein said contrast information derived from said plurality of extracted view sequences comprises contrast information derived from one or more corresponding view sequences.

2. The method according to claim 1, wherein said plurality of extracted view sequences comprises stereoscopic left view and right view sequences of reference fields or frames.

3. The method according to claim 1, comprising generating a 3D output video stream for playback via a 3D display based on said plurality of extracted view sequences comprising said modified contrast.

4. The method according to claim 3, comprising balancing brightness data of said generated 3D output video stream based on said contrast modification.

5. The method according to claim 3, comprising performing frame upconversion operations on said generated 3D output video stream utilizing frame or field interpolation.

6. The method according to claim 3, comprising locally performing graphics processing corresponding to said generated 3D output video stream.

7. The method according to claim 1, comprising performing noise reduction on one or more of said plurality of extracted view sequences.

8. The method according to claim 7, comprising performing said noise reduction separately and/or independently on each of said one or more of said plurality of extracted view sequences.

9. The method according to claim 1, comprising selecting one or more of said plurality of extracted view sequences for generating said contrast information utilized for said contrast enhancement.

10. The method according to claim 9, comprising selecting said one or more of said plurality of extracted view sequences based on a compression bitrate corresponding to each of said plurality of extracted view sequences.

11. A system for video processing, the system comprising:
one or more circuits and/or processors that are operable to extracting a plurality of view sequences from a compressed three-dimension (3D) input video stream; and
said one or more circuits and/or processors are operable to modify contrast for one or more of said plurality of extracted view sequences based on contrast information derived from said plurality of extracted view sequences, wherein said contrast information derived from said plurality of extracted view sequences comprises contrast information derived from one or more corresponding view sequences.

12. The system according to claim 11, wherein said plurality of extracted view sequences comprises stereoscopic left view and right view sequences of reference fields or frames.

13. The system according to claim 11, wherein said one or more circuits and/or processors are operable to generate a 3D output video stream for playback via a 3D display based on said plurality of extracted view sequences comprising said modified contrast.

14. The system according to claim 13, wherein said one or more circuits and/or processors are operable to balance brightness data of said generated 3D output video stream based on said contrast modification.

15. The system according to claim 13, wherein said one or more circuits and/or processors are operable to perform frame upconversion operations on said generated 3D output video stream utilizing frame or field interpolation.

16. The system according to claim 13, wherein said one or more circuits and/or processors are operable to locally perform graphics processing corresponding to said generated 3D output video stream.

17. The system according to claim 11, wherein said one or more circuits and/or processors are operable to perform noise reduction on one or more of said plurality of extracted view sequences.

18. The system according to claim 17, wherein said one or more circuits and/or processors are operable to perform said noise reduction separately and/or independently on each of said one or more of said plurality of extracted view sequences.

19. The system according to claim 11, wherein said one or more circuits and/or processors are operable to select one or more of said plurality of extracted view sequences for generating said contrast information utilized for said contrast enhancement.

20. The system according to claim 19, wherein said one or more circuits and/or processors are operable to select said one or more of said plurality of extracted view sequences based on a compression bitrate corresponding to each of said plurality of extracted view sequences.
